(19) United States
(12) Patent Application Publication
(10) Pub. No.: US 2020/0401666 A1
(43) Pub. Date: Dec. 24, 2020

(54) SYSTEMS AND METHODS FOR CLASSIFYING CONTENT ITEMS BASED ON USER COMMENTS

(71) Applicant: Facebook, Inc., Menlo Park, CA (US)

(72) Inventors: Umut Ozertem, San Carlos, CA (US); Ying Zhang, Palo Alto, CA (US)

(21) Appl. No.: 15/955,144

(22) Filed: Apr. 17, 2018

(51) Int. Cl. G06F 17/30; G06N 99/00

(52) U.S. Cl. CPC G06F 17/30601; G06N 99/005; G06F 17/30876

(57) ABSTRACT

Systems, methods, and non-transitory computer readable media can determine a relationship type between a first content item and a second content item based on a comment associated with at least one of the first content item and the second content item. A machine learning model can be trained based on the first content item, the second content item, and the determined relationship type. A related content item of a content item can be determined based on the machine learning model.

### FIELD OF THE INVENTION

The present technology relates to the field of social networks. More particularly, the present technology relates to techniques for classifying content items associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In one example, a content item can be presented on a profile page of a user. As another example, a content item can be presented through a feed for a user to access. Users may provide feedback associated with a content item, for example, through comments, reactions, etc.

### SUMMARY

Various embodiments of the present technology can include systems, methods, and non-transitory computer readable media configured to determine a relationship type between a first content item and a second content item based on a comment associated with at least one of the first content item and the second content item. A machine learning model can be trained based on the first content item, the second content item, and the determined relationship type. A related content item of a content item can be determined based on the machine learning model.

In some embodiments, the first content item and the second content item are determined to be related based on a social graph associated with a social networking system.

In certain embodiments, the first content item and the second item include one or more of: an article, a link, or a uniform resource locator (URL).

In an embodiment, the first content item is included in a post and the second content item is included in a comment associated with the post.

In some embodiments, a link to the first content item is included in a post and a link to the second content item is included in a comment associated with the post.

In certain embodiments, a relationship type between the first content item and the second content item is determined based on analyzing content of the comment associated with the post.

In an embodiment, the related content item can be provided in a feed of a user.

In some embodiments, the content item and the related content item are articles. Statements in the content item and the related content item can be extracted. A summary can be generated based on overlapping statements of the extracted statements.

In certain embodiments, the determining a related content item of a content item based on the machine learning model includes: receiving the content item and a relationship type as input to the machine learning model; and providing the related content item as output of the machine learning model.

In an embodiment, related content items can be received as input to the machine learning model, and a relationship type between the related content items and the related content item can be provided as output of the machine learning model.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example related content item determination module configured to determine related content items, according to an embodiment of the present technology.

FIG. 2A illustrates an example relationship module configured to determine related content items based on social graph data, according to an embodiment of the present technology.

FIG. 2B illustrates an example machine learning module configured to determine related content items based on a machine learning model, according to an embodiment of the present technology.

FIG. 2C illustrates an example related content item generation module configured to generate one or more related content items, according to an embodiment of the present technology.

FIG. 3A illustrates an example user interface for determining related content items, according to an embodiment of the present technology.

FIG. 3B illustrates an example functional block diagram for determining related content items, according to an embodiment of the present technology.

FIG. 4 illustrates an example first method for determining related content items, according to an embodiment of the present technology.

FIG. 5 illustrates an example second method for determining related content items, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Classifying Content Items Based on User Comments

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access. Users may provide feedback associated with a content item, for example, through comments, reactions, etc.

Conventional approaches specifically arising in the realm of computer technology can provide content items in a social networking system, for example, through a feed of a user. Examples of content items can include articles, links, etc. In some cases, conventional approaches can provide additional content items related to those content items. For example, for a content item provided in a feed of a user, a recommendation or suggestion can be presented to allow the user to access one or more related content items. However, under conventional approaches, it may be challenging to identify related content items that are relevant to a particular content item. Such conventional approaches employ computerized techniques that often inaccurately or unreliably determine a subject matter or other attributes associated with content items. Accordingly, attempts to identify related content items accordingly have been unpredictable and error prone.

An improved approach rooted in computer technology can overcome the foregoing and other disadvantages associated with conventional approaches specifically arising in the realm of computer technology. Based on computer technology, the disclosed technology can determine related content items based on user comments associated with content items. The disclosed technology can determine that content items are related to each other based on a social graph and also determine a type of relationship between content items that are related to each other based on user comments associated with content items. Content items can include, for example, any entities or objects that can be represented in a social graph associated with a social networking system. Content items can include various types of content. In some embodiments, a content item can be an article or a link to an article. For example, a link to an article can be included in a post. A user may create a comment in response to the post and also include a link to another article. The article associated with the post and the article associated with the comment may be determined to be related to each other because the articles relate to a common thread. Content of the comment can provide information indicative of a type of relationship between the article associated with the post and the article associated with the comment. Accordingly, a relationship type between the articles can be determined based on analyzing the content of the comment. Content items that are determined to be related and for which relationship types are determined can be used as training data for training a machine learning model. For content items that are provided as input, the trained machine learning model can determine related content items. In some embodiments, the disclosed technology can extract overlapping statements from related content items, such as articles associated with the related content items, to generate as a summary of the related content items. Additional details relating to the disclosed technology are provided below.

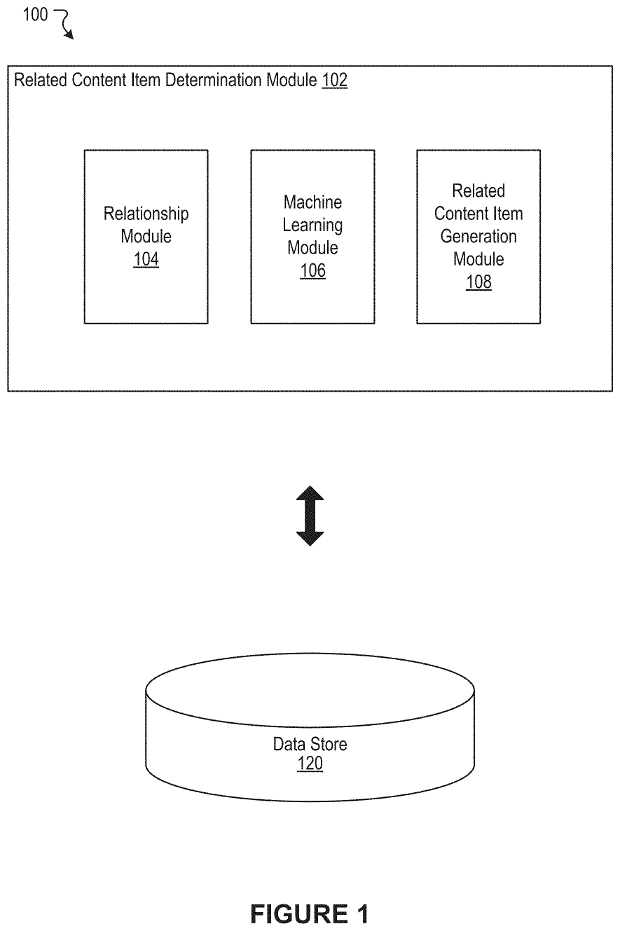

FIG. 1 illustrates an example system 100 including an example related content item determination module 102 configured to determine related content items, according to an embodiment of the present technology. Related content items can be reflected in a social graph. A social graph can include entities or objects and can reflect relationships, interactions, affinities, etc. among the entities or objects. For example, a social graph can include content items and reflect relationships among content items. Examples of content items can include articles, links, images, videos, audio, etc. For example, content items may be included in a post or a comment published in response to a post. For instance, a content item can be a link to an article, and a link to an article may be included in a post or in a comment in response to a post.

One or more posts can be provided in a feed of a user, such as a news feed. Users can take various types of actions in connection with a post, such as comment on a post, react to a post (e.g., like, dislike, etc.), share a post, etc. A post and comments in response to the post can be represented as entities or objects in the social graph. The disclosed technology can determine a relationship between the post and the comments in response to the post based on, for example, the social graph and their appearance in a common thread. Since a post and comments in response to the post can be considered to be related, a content item included in or associated with a post and a content item included in or associated with a comment in response to the post likewise can be considered to be related. For instance, the content item included in the post and the content item included in the comment can relate to the same subject matter, such as a particular topic, a particular event, etc. As an example, the present technology can consider an article or a link to the article included in a post and an article or a link to the article included in a comment in response to the post to be related. A comment in response to a post can include content, such as text, which can provide information relating to a type of relationship between a content item included in or associated with the post and a content item included in or associated with the comment. Accordingly, the present technology can analyze the content of a comment in order to determine a type of relationship between the content item included in or associated with the post and the content item included in or associated with the comment. Although content items are herein described in connection with articles or links to articles for illustrative purposes, the disclosed technology can apply to any type of content item.

The related content item determination module 102 can include a relationship module 104, a machine learning module 106, and a related content item generation module 108. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the related content item determination module 102 can be implemented in any suitable combinations. While the disclosed technology is described in connection with content items and related user comments associated with a social networking system for illustrative purposes, the disclosed technology can apply to any other type of system and/or content.

The relationship module 104 can determine related content items based on social graph data. For example, related content items can be determined based on a social graph. A relationship type between a content item associated with a post and a content item associated with a comment in response to the post can be determined, for example, based on content of the comment. Functionality of the relationship module 104 is described in more detail herein.

The machine learning module 106 can determine related content items based on a machine learning model. For example, a machine learning model can be trained based on training data including related content items for which relationship types have been determined. In an evaluation phase, the trained machine learning model can determine related content items for a content item. Functionality of the machine learning module 106 is described in more detail herein.

The related content item generation module 108 can generate one or more related content items. For example, related content items of a content item can be provided in a feed of a user. In some cases, statements from related content items can be extracted to generate a summary of the related content items. Functionality of the related content item generation module 108 is described in more detail herein.

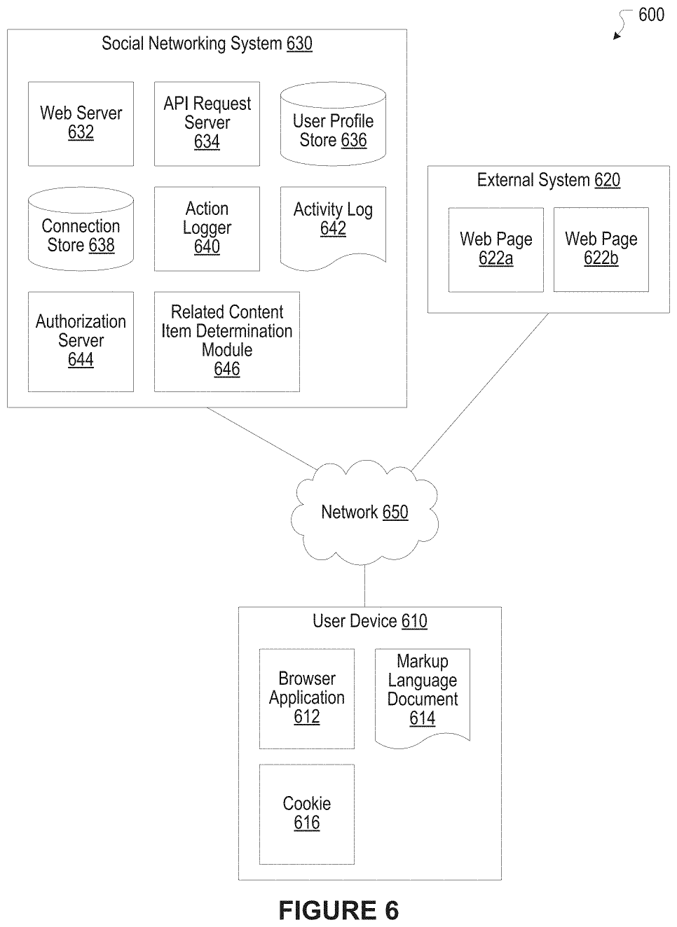

In some embodiments, the related content item determination module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the related content item determination module 102 can be, in part or in whole, implemented as software running on one or more computing devices or systems, such as on a server system or a client computing device. In some instances, the related content item determination module 102 can be, in part or in whole, implemented within or configured to operate in conjunction or be integrated with a social networking system (or service), such as a social networking system 630 of FIG. 6. Likewise, in some instances, the related content item determination module 102 can be, in part or in whole, implemented within or configured to operate in conjunction or be integrated with a client computing device, such as the user device 610 of FIG. 6. For example, the related content item determination module 102 can be implemented as or within a dedicated application (e.g., app), a program, or an applet running on a user computing device or client computing system. The application incorporating or implementing instructions for performing functionality of the related content item determination module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The data store 120 can be configured to store and maintain various types of data, such as the data relating to support of and operation of the related content item determination module 102. The data maintained by the data store 120 can include, for example, information relating to a social graph, content items, articles, links, relationships between content items, relationship types, machine learning models, statement extraction, summaries, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the related content item determination module 102 can be configured to communicate and/or operate with the data store 120. In some embodiments, the data store 120 can be a data store within a client computing device. In some embodiments, the data store 120 can be a data store of a server system in communication with the client computing device.

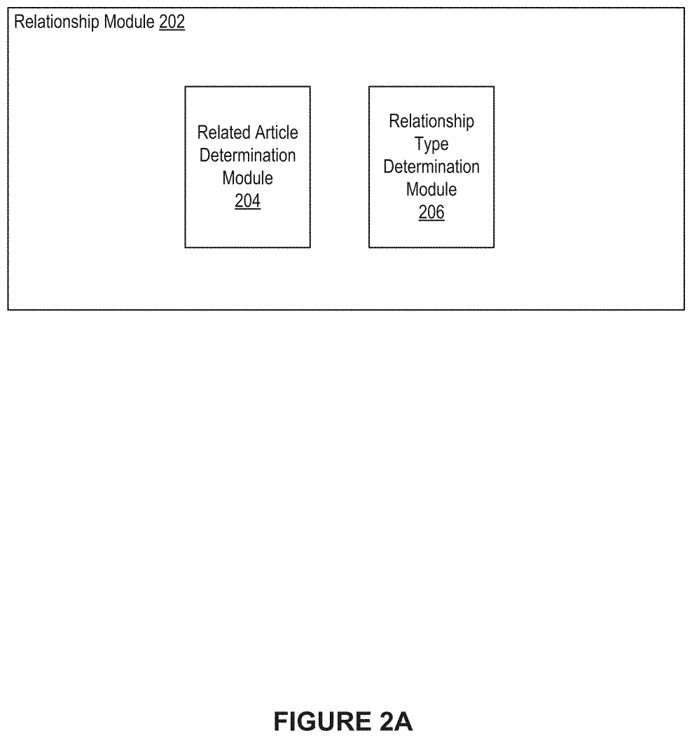

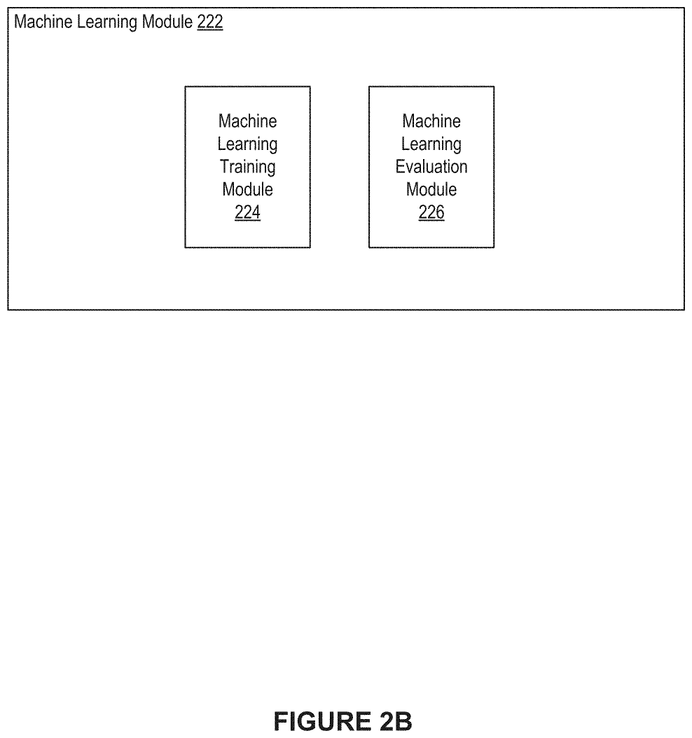

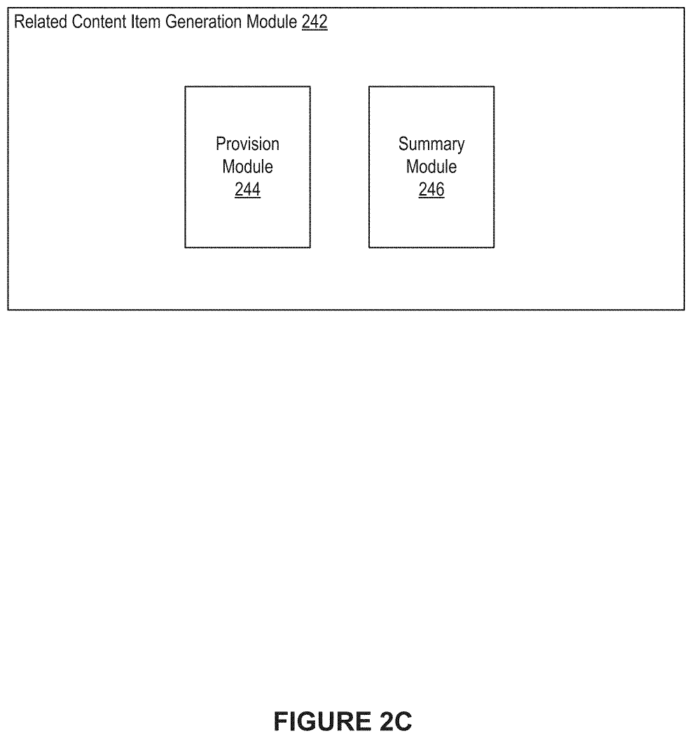

FIG. 2A illustrates an example relationship module 202 configured to determine related content items based on social graph data, according to an embodiment of the present technology. In some embodiments, the relationship module 104 of FIG. 1 can be implemented with the example relationship module 202. As shown in the example of FIG. 2A, the example relationship module 202 can include a related article determination module 204 and a relationship type determination module 206.

The related article determination module 204 can determine a set of related articles based on a social graph. For instance, the related article determination module 204 can determine a pair of related articles. As an example, a post can include a link to an article, and a comment in response to the post can also include a link to another article. In some embodiments, a link to an article can be a Uniform Resource Locator (URL). A post and a comment in response to the post can be represented in a social graph. The related article determination module 204 can identify the existence of a relationship between the post and the comment in response to the post. As some examples, if the post and the comment are within a threshold proximity (e.g., node distance) from one another in the social graph, are linked by a certain type of connection in the social graph, and/or are linked through a connection reflecting a threshold level of affinity, the related article determination module 204 can determine a relationship between post and the comment. When a post and a comment in response to the post are determined to be related, the related article determination module 204 can consider a link to an article in the post and a link to an article in the comment, as well as the articles themselves, to be related to each other. Accordingly, the related article determination module 204 can determine articles associated with links that are included in a post and a comment in response to the post to be related. As discussed herein, an article associated with a link that is included in a post can be referred to as a “post article.” A link to a post article can be referred to as a “post article link.” An article associated with a link that is included in a comment in response to a post can be referred to as a “comment article.” A link to a comment article can be referred to as a “comment article link.” While a pair of related articles has been discussed as an example, the present technology can apply to a set of related articles having any number of related articles.

The relationship type determination module 206 can determine a relationship type between articles included in a set of related articles. For example, a set of related articles can include a post article and one or more comment articles associated with the post article. The relationship type determination module 206 can determine a relationship type between a post article associated with a post and one or more comment articles related to the post article. In some embodiments, the relationship type determination module 206 can determine the relationship type based on content of a comment in response to the post, where the comment includes a comment article link associated with the one or more comment articles. The content of a comment can include, for example, text, symbols, image data, emojis, emoticons, audio data, and the like that can provide information indicative or suggestive of a type of relationship between a comment article and a post article. Examples of relationship types can include similar viewpoint, different or alternative viewpoint, etc. A similar viewpoint relationship type can indicate that articles provide similar viewpoints. For instance, similar viewpoints can be supporting viewpoints. A different or alternative viewpoint relationship type can indicate that articles provide different or alternative viewpoints from each other. For instance, different or alternative viewpoints can be opposing viewpoints. As an example, a comment including a comment article link can include content (e.g., text) indicating agreement with a post article, and the relationship type determination module 206 can determine that the relationship type between the post article and the comment article is similar viewpoint based on the content. As another example, a comment including a comment article link can include content indicating disagreement with a post article, and the relationship type determination module 206 can determine that the relationship type between the post article and the comment article is different or alternative viewpoint based on the content. Many variations are possible. In some embodiments, the relationship type determination module 206 can determine the relationship type between related articles based on sentiment analysis. For example, a suitable conventional sentiment analysis technique can be performed on content of a comment including a comment article link to determine a relationship type between an associated comment article and a post article. Sets of related articles for which relationship types are determined based on content of comments can be used as training data for training a machine learning model, as described below. All examples herein are provided for illustrative purposes, and there can be many variations and other possibilities.

FIG. 2B illustrates an example machine learning module 222 configured to determine related content items based on a machine learning model, according to an embodiment of the present technology. In some embodiments, the machine learning module 106 of FIG. 1 can be implemented with the example machine learning module 222. As shown in the example of FIG. 2B, the example machine learning module 222 can include a machine learning training module 224 and a machine learning evaluation module 226.

The machine learning training module 224 can train a machine learning model to determine related articles. Training data for training the machine learning model can include sets of related articles for which relationship types have been determined, for example, by the relationship module 202, as described above. The training data (e.g., labeled data) can include information relating to sets of articles and corresponding relationships types. The training data can include various features. For example, features can relate to article attributes, relationship type attributes, user attributes, etc. Article attributes can include any attributes associated with articles. Examples of article attributes can include a title, an author, a source (e.g., a publisher, a media outlet, a website, a channel, etc.), a length of an article, a link to an article (e.g., a URL), content or text of an article, a user associated with a post including a link to an article, a user associated with a comment including a link to an article, whether an article is a post article, whether an article is a comment article, etc. Relationship type attributes can include any attributes associated with relationships or relationship types between articles. Examples of relationship type attributes can include a relationship type, content of a comment including a link to an article, sentiment associated with content of a comment including a link to an article, etc. As described above, examples of relationship types can include similar viewpoints, different or alternative viewpoints, etc. User attributes can include any attributes associated with users. Examples of user attributes can include a location (e.g., a country, state, county, city, etc.), an age, an age range, a gender, a language, interests (e.g., topics in which the user has expressed interest), a computing device, an operating system (OS), etc. Many variations are possible. The machine learning training module 224 can retrain the machine learning model based on new or updated training data.

The machine learning evaluation module 226 can apply the trained machine learning model to determine related articles. For example, the trained machine learning model can be applied to feature data relating to one or more articles and/or a relationship type. In some embodiments, the trained machine learning model can accept two related articles as input and provide a relationship type between the articles, if any, as output. For example, the trained machine learning model can output a ranking or a score for each possible relationship type that can exist between articles. The ranking or the score can be indicative of a likelihood of a particular relationship type being applicable to the articles. The machine learning evaluation module 226 can rank relationship types based on their respective scores. In other embodiments, the trained machine learning model can accept an article and a relationship type as input and provide another related article as output. For example, the trained machine learning model can output a ranking or a score for an article that can be deemed related to the input article. The ranking or the score can be indicative of a likelihood of the article having the input relationship type in connection with the input article. The machine learning evaluation module 226 can rank potential related articles for the input article based on respective scores.

In some embodiments, the trained machine learning model can provide as output only the top ranked relationship type or the top ranked related article. In other embodiments, the trained machine learning model can provide as output a relationship type or a related article having a score that satisfies a threshold value. The relationship types or the related articles that satisfy applicable respective threshold values can be provided as output based on an order of the ranking. While the trained machine learning model is described as accepting two articles as input, or an article and a relationship type as input, for illustrative purposes, the trained machine learning model can accept any number of articles and/or relationship types as input, as desired. Similarly, the trained machine learning model can provide any number of articles and/or relationship types as output, as desired. One or more machine learning models discussed in connection with the related content item determination module 102 and its components, such as the machine learning module 222, can be implemented separately or in combination, for example, as a single machine learning model, as multiple machine learning models, as one or more staged machine learning models, as one or more combined machine learning models, etc. All examples herein are provided for illustrative purposes, and there can be many variations and other possibilities.

FIG. 2C illustrates an example related content item generation module 242 configured to generate one or more related content items, according to an embodiment of the present technology. In some embodiments, the related content item generation module 108 of FIG. 1 can be implemented with the example related content item generation module 242. As shown in the example of FIG. 2C, the related content item generation module 242 can include a provision module 244 and a summary module 246.

The provision module 244 can provide related articles within a social networking system. For example, related articles can be determined by the machine learning module 222, as described above. In some embodiments, the provision module 244 can provide related articles in a feed of a user. As discussed, the related articles can provide similar viewpoints, provide different or alternative viewpoints, etc. For example, if a feed of a user includes an article or a link to an article, the provision module 244 can embed in the feed of the user recommendations or suggestions that, if selected, can provide the user with access to related articles. As another example, the provision module 244 can directly embed in the feed of the user content items that provide access to related articles. In this way, the disclosed technology can facilitate identification and provision of additional, related articles that reflect more complete coverage of subject matter reflected in an original article that is accessible to a user.

The summary module 246 can extract statements from related articles. For example, the summary module 246 can analyze content of an article in order to extract one or more statements from the article. Extracted statements of an article can be used to provide a summary for related articles. The summary module 246 also can identify overlapping or common statements between related articles. There may be an overlap in statements extracted from different articles. Overlapping statements are likely to relate to supported, verifiable, accurate, or otherwise objective statements relating to a subject matter since the overlapping statements are included in multiple articles. In addition, the summary module 246 can generate a summary for related articles based on the overlapping statements. The summary can include one or more of the overlapping statements. The summary can be provided in connection with the related articles. As an example, the summary can be provided with recommendations or suggestions to access related articles in a feed of a user. As another example, the summary can be provided with presentation of links to the related articles. In some embodiments, statement extraction, identification of overlapping statements, and/or generation of a summary of related articles based on overlapping statements can be based on machine learning techniques. All examples herein are provided for illustrative purposes, and there can be many variations and other possibilities.

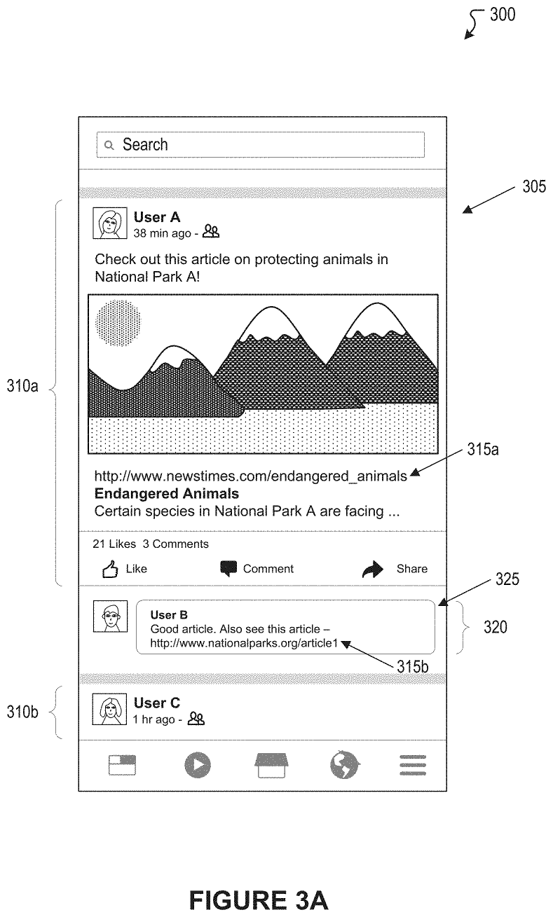

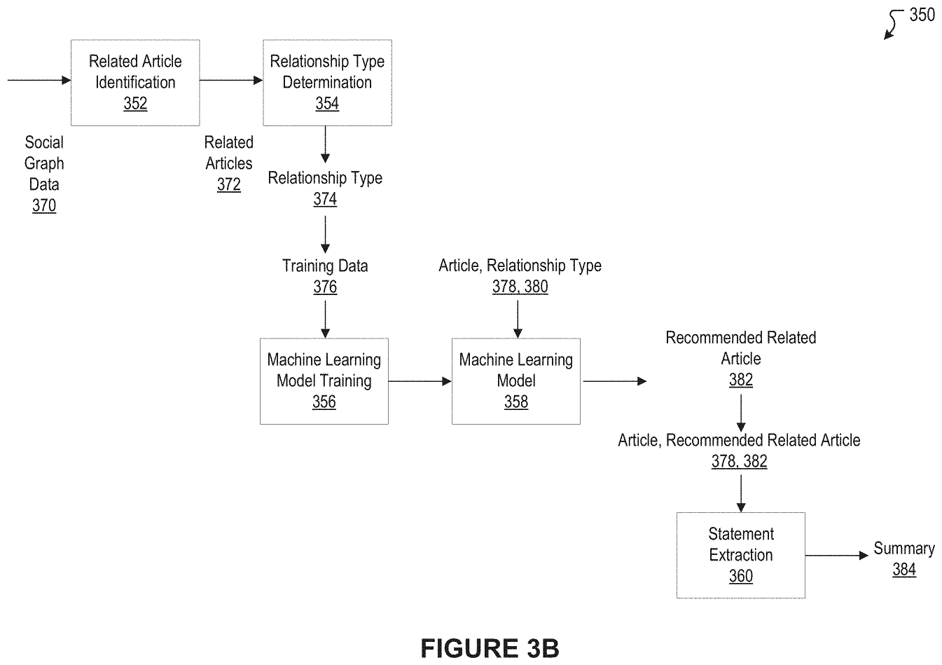

FIG. 3A illustrates an example user interface 300 for determining related content items based on the related content item determination module 102, according to an embodiment of the present technology. The user interface 300 shows a feed 305 of a user. The feed 305 includes posts 310a and 310b. The post 310a includes a link 315a. The link 315a can be a post article link. A user may create a comment 320 in response to the post 310a. The comment 320 also includes a link 315b. The link 315b can be a comment article link. The comment 320 includes content 325. In the example of FIG. 3A, the content 325 of the comment 320 includes text information (e.g., “Good article. Also see this article”). Since the post 310a and the comment 320 have been determined to be related to each other in a social graph, the link 315a and the link 315b can be determined to be related. For example, the link 315a and the link 315b can relate to the same or similar subject matter. Accordingly, articles corresponding to the link 315a and the link 315b can also be determined to be related. A relationship type between articles corresponding to the link 315a and the link 315b can be determined based on the content 325 of the comment 320 including the link 315b. In the example of FIG. 3A, the relationship type can be determined to be similar viewpoints. The articles corresponding to the link 315a and the link 315b can be included in training data for training a machine learning model. For example, the training data can include sets of related articles for which relationship types are determined based on content of associated comments. The trained machine learning model can determine related articles for an article. All examples herein are provided for illustrative purposes, and there can be many variations and other possibilities.

FIG. 3B illustrates an example functional block diagram 350 for determining related content items based on the related content item determination module 102, according to an embodiment of the present technology. Various functionalities associated with the functional block diagram 350 can be performed by the related content item determination module 102, as discussed herein. At block 352, related articles 372 can be identified based on social graph data 370. For example, a post article and a comment article can be determined to be related. At block 354, a relationship type 374 can be determined for the related articles 372. Training data 376 for training a machine learning model can be prepared based on sets of related articles 372 and corresponding relationship types 374. At block 356, a machine learning model can be trained based on the training data 376. In one embodiment, the trained machine learning model 358 can accept an article 378 and a relationship type 380 as input and provide a recommended related article 382 for the article 378 as output. At block 360, statement extraction can be performed on the article 378 and the recommended related article 382 to generate a summary 384 of the article 378 and the recommended related article 382. In some instances, the summary 384 can be presented in connection with a recommendation to access the articles. All examples herein are provided for illustrative purposes, and there can be many variations and other possibilities.

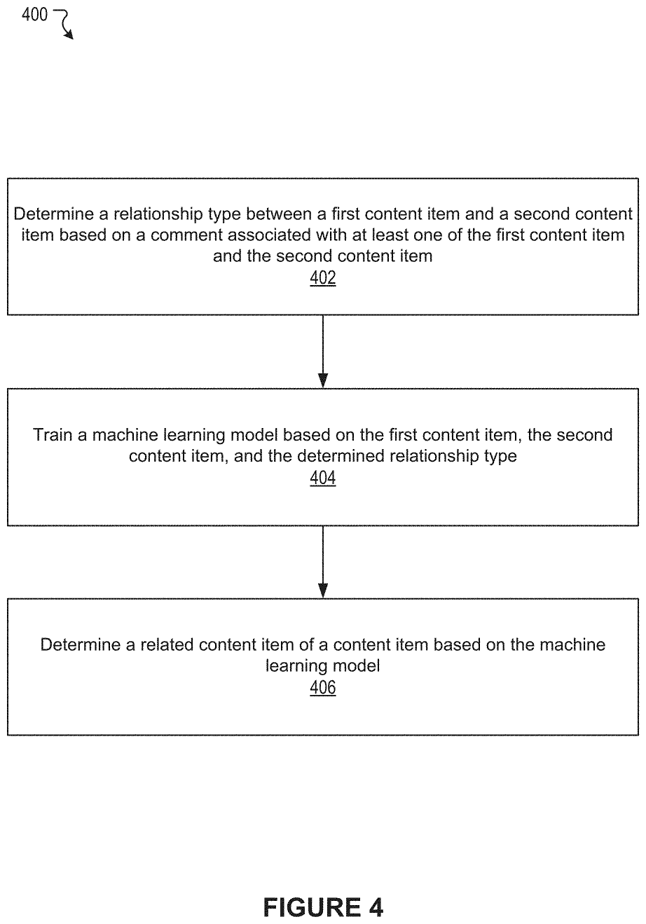

FIG. 4 illustrates an example first method 400 for determining related content items, according to an embodiment of the present technology. It should be understood that there can be additional, fewer, or alternative steps performed in similar or alternative orders, or in parallel, based on the various features and embodiments discussed herein unless otherwise stated.

At block 402, the example method 400 can determine a relationship type between a first content item and a second content item based on a comment associated with at least one of the first content item and the second content item. At block 404, the example method 400 can train a machine learning model based on the first content item, the second content item, and the determined relationship type. At block 406, the example method 400 can determine a related content item of a content item based on the machine learning model. Other suitable techniques that incorporate various features and embodiments of the present technology are possible.

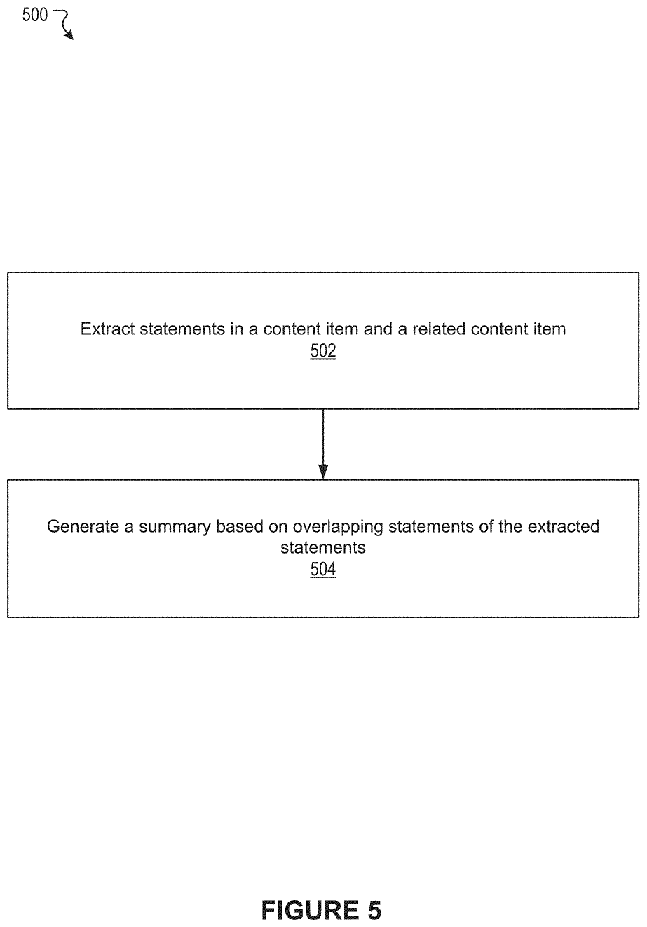

FIG. 5 illustrates an example second method 500 for determining related content items, according to an embodiment of the present technology. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can extract statements in a content item and a related content item. At block 504, the example method 500 can generate a summary based on overlapping statements of the extracted statements. Other suitable techniques that incorporate various features and embodiments of the present technology are possible.

It is contemplated that there can be many other uses, applications, features, possibilities, and/or variations associated with various embodiments of the present technology. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a related content item determination module 646. The related content item determination module 646 can be implemented with the related content item determination module 102, as discussed in more detail herein. In some embodiments, one or more functionalities of the related content item determination module 646 can be implemented in the user device 610.

### Hardware Implementation

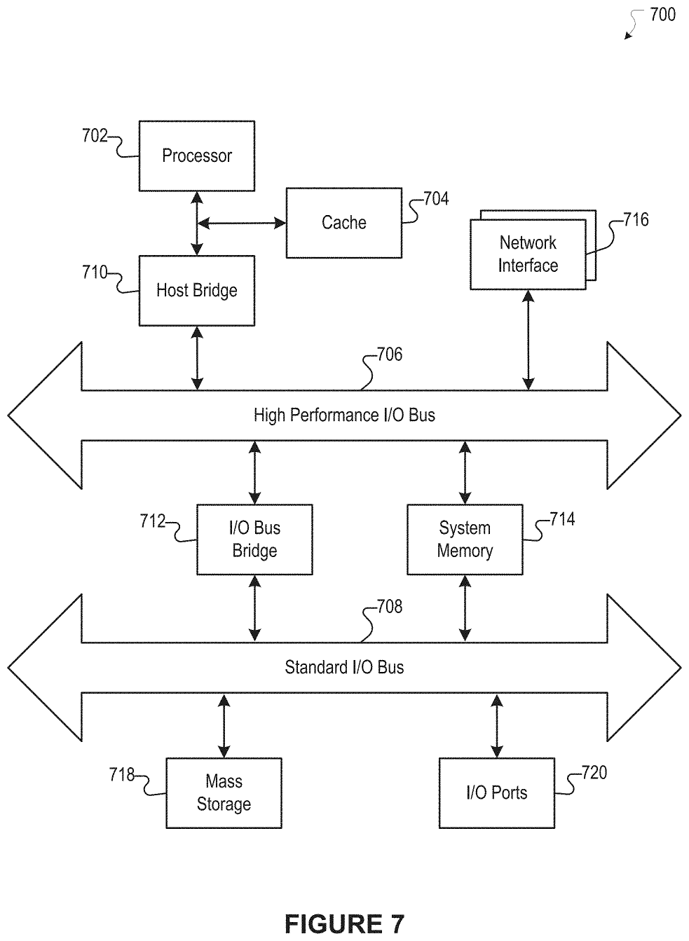

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
determining, by a computing system, a relationship type between a first content item and a second content item based on a comment associated with at least one of: the first content item or the second content item, wherein the determined relationship type is at least one of a plurality of relationship types including a similar viewpoint, a different viewpoint, and an alternative viewpoint;
training, by the computing system, a machine learning model based on the first content item, the second content item, and the determined relationship type; and
determining, by the computing system, a related content item of a content item by the machine learning model based on a ranking of the plurality of relationship types between the related content item and the content item.

2. The computer-implemented method of claim 1, wherein the first content item and the second content item are determined to be related based on a social graph associated with a social networking system.

3. The computer-implemented method of claim 1, wherein the first content item and the second item include one or more of: an article, a link, or a uniform resource locator (URL).

4. The computer-implemented method of claim 1, wherein the first content item is included in a post and the second content item is included in a comment associated with the post.

5. The computer-implemented method of claim 1, wherein a link to the first content item is included in a post and a link to the second content item is included in a comment associated with the post.

6. The computer-implemented method of claim 5, wherein the relationship type between the first content item and the second content item is determined based on analyzing content of the comment associated with the post.

7. The computer-implemented method of claim 1, further comprising providing the related content item in a feed of a user.

8. The computer-implemented method of claim 1, wherein the content item and the related content item are articles, and wherein the method further comprises:
extracting statements in the content item and the related content item; and
generating a summary based on overlapping statements of the extracted statements.

9. The computer-implemented method of claim 1, wherein the determining a related content item of the content item based on the machine learning model includes:
receiving the content item and an input relationship type as input to the machine learning model; and
providing the related content item as output of the machine learning model based on the ranking of the plurality of relationship types between the related content item and the content item, wherein the ranking indicates a likelihood of the content item and the related content item having the input relationship type.

10. The computer-implemented method of claim 1, further comprising:
receiving related content items as input to the machine learning model; and
providing an output relationship type between the related content items as output of the machine learning model.

11. A system comprising:
at least one hardware processor; and
a memory storing instructions that, when executed by the at least one processor, cause the system to perform:
determining a relationship type between a first content item and a second content item based on a comment associated with at least one of the first content item and the second content item, wherein the determined relationship type is at least one of a plurality of relationship types including a similar viewpoint, a different viewpoint, and an alternative viewpoint;
training a machine learning model based on the first content item, the second content item, and the determined relationship type; and
determining a related content item of a content item by the machine learning model based on a ranking of the plurality of relationship types between the related content item and the content item.

12. The system of claim 11, wherein the first content item and the second content item are determined to be related based on a social graph associated with a social networking system.

13. The system of claim 11, wherein a link to the first content item is included in a post and a link to the second content item is included in a comment associated with the post.

14. The system of claim 13, wherein the relationship type between the first content item and the second content item is determined based on analyzing content of the comment associated with the post.

15. The system of claim 11, wherein the content item and the related content item are articles, and the instructions further cause the system to perform:
extracting statements in the content item and the related content item; and
generating a summary based on overlapping statements of the extracted statements.

16. A non-transitory computer readable medium including instructions that, when executed by at least one hardware processor of a computing system, cause the computing system to perform a method comprising:
determining a relationship type between a first content item and a second content item based on a comment associated with at least one of the first content item or the second content item, wherein the determined relationship type is at least one of a plurality of relationship types including a similar viewpoint, a different viewpoint, and an alternative viewpoint;
training a machine learning model based on the first content item, the second content item, and the determined relationship type; and
determining a related content item of a content item by the machine learning model based on a ranking of the plurality of relationship types between the related content item and the content item.

17. The non-transitory computer readable medium of claim 16, wherein the first content item and the second content item are determined to be related based on a social graph associated with a social networking system.

18. The non-transitory computer readable medium of claim 16, wherein a link to the first content item is included in a post and a link to the second content item is included in a comment associated with the post.

19. The non-transitory computer readable medium of claim 18, wherein the relationship type between the first content item and the second content item is determined based on analyzing content of the comment associated with the post.

20. The non-transitory computer readable medium of claim 16, wherein the content item and the related content item are articles, and wherein the method further comprises:
extracting statements in the content item and the related content item; and
generating a summary based on overlapping statements of the extracted statements.
